(19) United States
(12) Patent Application Publication
(10) Pub. No.: US 2008/0061473 A1
(43) Pub. Date: Mar. 13, 2008

(54) System and method for engraving semi-soft and malleable items

(76) Inventors: Kevin Laracey, Natick, MA (US); John W. Loudon, Columbus, OH (US); Aaron J. Loudon, Newtown, PA (US)

Correspondence Address: MCDERMOTT WILL & EMERY LLP, 600 13TH STREET, N.W., WASHINGTON, DC, 20005-3096, US

(21) Appl. No.: 11/819,711

(22) Filed: Jun. 28, 2007

Related U.S. Application Data
(60) Provisional application No. 60/816,884, filed on Jun. 28, 2006.

(51) Int. Cl. B29C 59/02

(52) U.S. Cl. 264/293; 425/112

(57) ABSTRACT

A method and apparatus are provided for engraving semi-soft and malleable items such as soaps and candles, to create large quantities of personalized products where each item could have unique markings, such as a monogram, logo, word, or saying. Embodiments include a machine tool having a spindle, a stylus, and a nosecone comprising a top portion attachable to the spindle. The nosecone also has a bottom rim for contacting stock to be machined by the machine tool and for distributing a downward pressure of the machine tool applied to the stock; and a body between the bottom rim and the top portion, for preventing contact between the stock and the spindle and for preventing a stylus of the machine tool from penetrating the stock before a predetermined amount of pressure is applied to the stock from the machine tool. A holding device of a rigid material, having at least one nest cavity, holds the stock while the pressure is applied to the stock.

### RELATED APPLICATIONS

This application claims the benefit of U.S. Provisional Application No. 60/816,884, filed on Jun. 28, 2006, entitled “DESCRIPTION OF THE PROCESS & APPARATUS USED TO ENABLE MASS PRODUCTION OF PERSONALIZED, CUSTOM SOAPS AND CANDLES”, the disclosure of which also is entirely incorporated herein by reference.

### TECHNICAL FIELD

The disclosure relates generally to creating personalized and customized items from stock, and more particularly to creating personalized soap and candles by engraving semi-soft stock.

### BACKGROUND

Soaps, in addition to providing cleansing capabilities, are frequently presented as gifts or used as advertising vehicles. Often, these soaps include decorations, such as logos, monograms, slogans, and/or other words. Soap bars and cakes can be transformed into decorative items by molding the bar into a pleasing shape, and also by placing markings, including letters, symbols, words, etc., onto or into the soap bar or cake. For example, it is common to see soap with markings indicating the name and/or logo of a manufacturer or other entity. Entities such as hotels, country clubs amusement parks, and/or other establishments often provide visitors with soap bars or cakes marked with the entities' name, logo, and/or other insignia.

Similarly, candles may be decorated to include a logo, monogram, or other words in order to transform the candle into a decorative gift or memorabilia. The decorative candles may serve as a commemorative item designed to evoke a memory, such as a birth or marriage. Like soap, candles can be transformed into decorative and commemorative items by molding the candles into desired shapes, incorporating a scent, and/or placing markings on the candle.

There is significant demand for an economical method of applying high quality markings to large quantities of soaps and candles where each soap or candle could have a unique marking. Typical methods, however, have pre-supposed that a large number of items having identical markings applied thereto are to be mass produced. Previously, no economical methods existed for creating large quantities of items, such as soaps and candles, whereby each soap or candle would include unique, high quality markings that might be appropriate for only a single recipient or a small group of recipients, such as a three letter monogram representing the first letter of the recipient's first, middle, and last names, the recipient's last name, or a logo of a family crest. The present disclosure provides an economical method and apparatus for creating large quantities of soap, candles, or other items where every item could have unique markings. As a result, the present disclosure opens up entirely new markets, especially for commemorative, holiday, or special occasion gifts where individuals or groups can have high quality items created featuring letters, monograms, symbols, slogans and/or logos in lots as small as a single item, for a cost that is a fraction of what would be incurred employing conventional methods and machinery.

Conventional methods for applying markings to soap bars and cakes, and also to candles, have involved techniques such as embedding or incorporating objects or materials inside a soap bar to facilitate the display of the markings, using a press to apply markings to the soap or candle, using a mold to apply markings to the soap or candle, and applying a label to soap in order to affix markings to the soap bar. However, several drawbacks are associated with each of these methods.

For example, the method of embedding or incorporating objects or materials inside the soap or candle makes it difficult and expensive to create unique products, whereby each item has unique markings. Varying the embedded object requires complex and costly manufacturing systems, as well as sophisticated inventory and production control systems to handle all of the permutations of combinations of embedded objects. There are also frequently difficulties associated with the aesthetics of the area where the inserted object or incorporated material meets with the surrounding soap or candle wax, especially if the surrounding base soap or wax obscures some portion of any marks incorporated into or included on the surface of the embedded object or material, resulting in illegible or indistinct lettering or marking. This is sometimes referred to as a registration error. In addition, the included objects may interfere with the burning of a candle when it is lit. Moreover, the included objects may be something that the user of a soap bar may have to dispose of once the soap around the included object has dissolved.

Using a press to apply markings also has drawbacks. First, a die must be created by a process which is typically expensive and time consuming. Additionally, once a die is mounted into the press used to create the products, each item moved through the press can only be marked with the marks found on the die. Varying the marks from item to item so that each item would have a unique set of marks would require that a new die be created and mounted before pressing the subsequent item. This process would be cost and time prohibitive for producing large volumes of products where it was desirable to have different markings on each item. In addition, the press process also is limited by the quality and variety of the markings it can produce, since the dies wear down reducing the clarity of the image they produce on the soap or candle. Further, the quality of the products produced using the die may be diminished due to excess build-up of soap or candle wax materials. Still further, since candle wax has to be quite hard to prevent excessive melting of the wax when the candle is lit, the process of using a die to apply markings to candles can frequently cause displacement of the wax and fractures in the wax. In the process of being displaced, the displaced wax material can appear as white streaks or blotches on the candle, marring the appearance of the candle

The method of using a mold to apply markings to a candle or soap has drawbacks similar to those associated with using a die and press. First, the process requires creating a mold, which is typically expensive and time-consuming. Once a mold is made and placed into a molding machine, each soap bar or candle can only be marked with the marks found on the then-mounted mold. Varying the marks from soap bar to soap bar, or from candle to candle, requires that a new mold be created and then mounted before molding the subsequent soap bar or candle, a process which would be cost and time prohibitive for producing large volumes of soap bars or candles, where it is desirable to have the markings be unique for each soap bar or candle. In addition, the press process also is limited by the quality and variety of the markings it can produce, since the surface of the mold can become coated with excess soap or wax, reducing the clarity of the image produced when the soap or candle is molded.

One drawback associated with applying a label to affix markings, particularly with respect to soaps, is that the label material will be different from the soap material and would not have the cleansing ability of soap. Further, the texture of the affixed label may be unpleasant to the skin. As with the other methods described above, applying labels makes it difficult to change the markings from soap bar to soap bar, especially when it is necessary to produce high volumes of soap, where each bar could have unique markings. Varying the label from soap bar to soap bar would require complex manufacturing systems to ensure that the right label was affixed to the appropriate bar, as well as sophisticated inventory and production control systems to handle all the permutations of the labels.

Furthermore, conventional engraving machines and milling machines have been unable to engrave semi-soft materials like soaps and candles without marring the appearance. Accordingly, none of the above-described methods are useful in engraving personalized soaps or candles, which consist of semi-soft stock materials, in small or individual batches having unique markings.

### SUMMARY

Accordingly, this disclosure relates to systems, methods, and apparatus for placing marks, such as a monogram, logo, word, or saying, on semi-soft and malleable items to create personalized products, such as soap and candles. The system may comprise a machine tool having a spindle and a stylus, a nosecone comprising a top portion attachable to a spindle of the machine tool; a bottom rim for contacting stock to be machined by the machine tool and for distributing a downward pressure of the machine tool applied to the stock; and a body between the bottom rim and the top portion, for preventing contact between the stock and the spindle and for preventing a stylus of the machine tool from penetrating the stock before a predetermined amount of pressure is applied to the stock from the machine tool. A holding device comprised of a semi-rigid material has at least one nest cavity for holding the stock while the pressure is applied to the stock.

A method for producing one or more products from semi-soft stock is also provided, comprising providing a machine tool, affixing a top portion of a nosecone to a spindle of the machine tool, providing a holding device having at least one nest cavity for holding the stock, placing the stock in the nest cavity, defining the location of the holding device to the machine tool, programming the machine tool with engraving instructions, contacting the bottom rim of the nosecone with the stock, distributing a downward pressure of the machine tool to the stock through the bottom rim, creating a low pressure area in the region enclosed by the stock and interior of the nosecone by applying a vacuum to the suction hose; and engraving the stock according to the engraving instructions.

### BRIEF DESCRIPTION OF THE DRAWINGS

FIG. 1 depicts an overall system for creating personalized stock items, in accordance with various disclosed embodiments.

FIG. 2 depicts a nest device for holding stock items, in accordance with various disclosed embodiments.

FIG. 3 depicts an example of a nosecone device, in accordance with various disclosed embodiments.

FIG. 4 depicts another example of a nosecone device, in accordance with various disclosed embodiments.

FIG. 5 depicts a nosecone device attached to a spindle, in accordance with various disclosed embodiments.

FIG. 6 depicts a process of programming an engraving/milling machine, in accordance with various disclosed embodiments.

FIG. 7 depicts a process for initiating and filling customer orders, in accordance with various disclosed embodiments.

### DETAILED DESCRIPTION OF THE DISCLOSURE

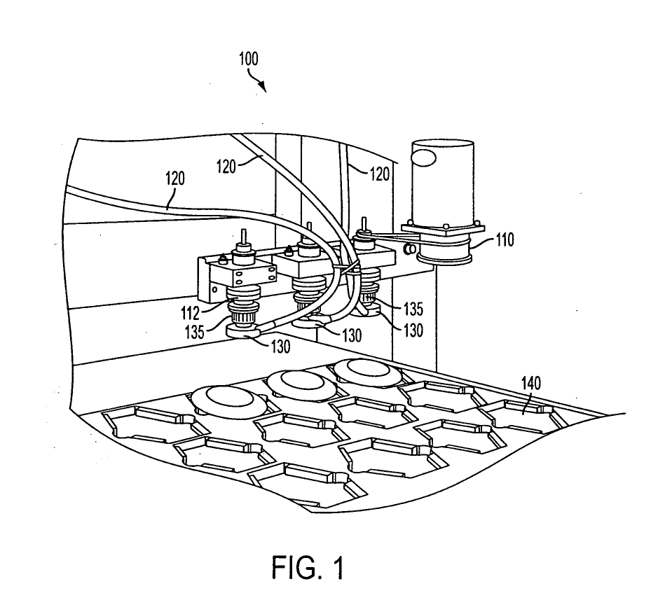

FIG. 1 depicts a system 100 which may be used to created large quantities of personalized items from semi-soft & malleable stock, such as personalized soap or candles. Each item could have unique markings, such as a monogram, logo, word, or saying. For example, customized soaps may be created using soap stock such as, for example, a triple milled soap stock. When creating candles, candle stock such as paraffin based, soy based, or palm wax based candle stock may be used. Other personalized items may be created using soft stock such as, for example, personalized chocolates, cheese, dog biscuits, and/or other customized products.

System 100 includes a machine tool 110, such as a conventional engraving or milling machine, suction hoses 120, nosecones 130, and a nest 140. Alternatively, machine tool 110 can be a conventional computer numerical control (CNC) machine. The machine tool 110 depicted in FIG. 1 comprises three heads, however, the number of heads may vary. Each head of machine tool 110 may include a stylus (not shown) held by a spindle 112, which is used to apply pressure to the stock, thereby producing markings on the stock. Each nosecone 130 comprises a spindle connector 135 for attaching the nosecone 130 to the spindle 112.

As depicted in FIG. 1, a nosecone 130 is attached to each head of the machine tool 110. Typical conventional engraving/milling equipment has not been designed to work with soft materials, such as soap and wax. Accordingly, the z-axis pressure (i.e., the pressure that the cutting tip exerts in a downward direction onto the surface being marked/cut into) controls on these devices do not typically allow for applying the very light amount of pressure required to engrave soft, semi-soft & malleable stock materials without scratching the stock or placing other undesirable marks on the stock. Normally, all of the force of the engraving heads would be exerted on the very tip of the cutting stylus, which is appropriate for using engraving or milling machines to engrave hard substances such as metal, plastic, and wood. Even at the lowest pressure setting on many commercially available engraving/milling machines, this typically results in the blade going completely through semi-soft stock such as soap or candle stock, or at a minimum going to an undesirable depth and creating a mark that would not be aesthetically pleasing. The nosecones 130 “spread out” the pressure applied by the engraving machine spindle. The reduced pressure of the cutting head on the stock protects the semi-soft stock material from being deformed during the marking process, and also ensures a consistent cutting depth. Suction hoses 120 may be provided for creating a sealed area that concentrates suction from the suction hose to the area around the cutting stylus. Additionally, the suction hoses 120 may be configured to evacuate waste material removed by the cutting stylus from the surface of the stock, so that it does not become re-embedded into the engraved area of the soap or candle, marring the appearance of the engraved area.

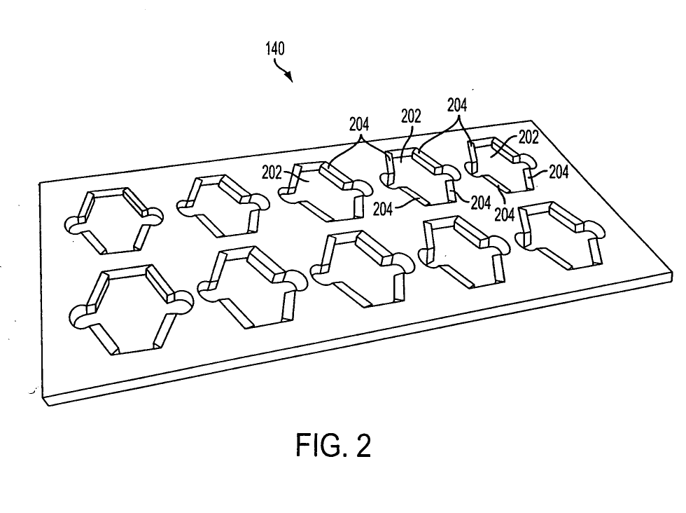

Nest 140 may be provided as a holding device to fix the stock into a particular position below the cutting stylus, and to protect the unmarked side of the stock from being marred by contact with the surface of the engraving table. A nest 140 is depicted in greater detail in FIG. 2. Nest 140 is configured to hold the stock in a fixed position beneath the stylus of the machine tool 110, preventing marring of the surface of the stock that touches the nest, which typically rests on top of an engraving table. Nest 140 may include a plurality of nest cavities 202, and may be made from a semi-rigid material that is somewhat flexible such as, for example, delrin, rubber, polyester foam, cork, etc., which can hold the semi-soft soap or candle securely without marring their edges, as would be the case if a rigid material were used. Other semi-rigid materials which can be shaped relatively easily without leaving burrs or other rough surfaces may be used to construct nest 140.

Nest 140 may be configured to position the surface of a stock item in a location defined by the machine tool 110, enabling markings to be placed on the stock in the desired location. The number of nest cavities 202 may be an arbitrary number, limited only by the ability of the heads of the machine tool 110 to move over the positions. Nest 140 may be configured to accommodate one or more shapes and sizes of stocks. According to some embodiments, nest cartridges may be provided which may be plugged into one or more of the nest cavities 202. Thus, for example, in a nest consisting of 10 rows and 6 columns, each row/column position may contain a nest cartridge designed to hold stock of a particular shape.

According to some embodiments, each nest cavity 202 may be lined with strips 204 of a rubber or other flexible material. This eases the ability to hold the stock firmly in place while providing enough flexibility to accommodate slight variations in stock size. Although four strips 204 are shown in each cavity 202 in FIG. 2, the number of strips per cavity can be varied to suit. Additionally, the rubber material may be used to cushion the stock from impacts with more rigid nest material during the engraving process, helping to prevent scratching or marring of the soap or candle stock.

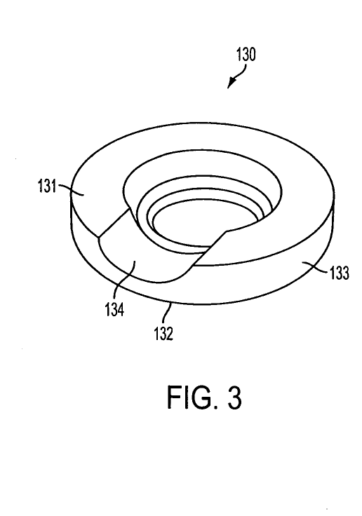

An example of a nosecone 130 is depicted in greater detail in FIG. 3. As described above, nosecone 130 may be attached to the spindle/cutting head of a machine tool such as a milling/engraving machine. Nosecone 130 may comprise a top portion 131 which attaches to a spindle of an engraving/milling machine via the spindle connector 135 shown in FIG. 1, a bottom rim portion 132 for contacting the stock to be milled or engraved, and a body portion 133 for preventing contact between the stock and the spindle. Additionally, body portion 133 prevents a stylus of the engraving/milling machine from penetrating the stock before a preset amount of pressure is applied to engrave the stock by spreading the downward force of the stylus across a broader area of the stock's surface.

Nosecone 130, as depicted in FIG. 3, may be tubular in shape. However, other shapes may be used such that the shape of the nosecone fits the heads of the engraving/milling machine. A groove 134 may be provided as a through-hole for connection of nosecone 130 to a suction hose, as described in greater detail below. The suction hose connects with the interior of the nosecone body via the through-hole 134 for removing particulates and creating a sealed, low pressure area when the bottom rim of the nosecone 130 contacts the stock.

Nosecone 130 may be manufactured using a smooth, flat material that insulates the stock from contact with the surface of the spindle, such as a conventional somewhat flexible polymer. For example, a nosecone may be comprised of a flat plastic surface, having rounded edges and a somewhat flexible backing. Because the spindle has a hard metal surface, if it makes contact with the stock, it is likely to cause marring or scratching to the surface of the stock. Accordingly, using nosecone 130, which is made of a smooth material, undesirable marks or scratches may be decreased or eliminated.

Providing a nosecone, such as nosecone 130, lessens the pressure applied on the tip of the cutting stylus by transferring some of the downward pressure to the area of the stock immediately surrounding the area that is impacted by the stylus. This may be accomplished by affixing the nosecone to the spindle of the engraving/milling machine. The spindle then transfers some of the downward pressure through the nosecone to the surface of the stock.

Nosecone 130 may also be configured to ensure a consistent cutting depth. Different batches of items, such as soap or candle stock, may have variations in thickness from batch to batch and bar to bar due to differences in moisture content, chemical composition, and/or other differences. Accordingly, when applying pressure to variable stock items, it is not possible to instruct the machine to move its cutting head to the same position in the z axis direction for each piece of stock. Instead, the cutting head should be moved to a z axis position relative to the z axis position where the nosecone first makes contact with the surface of the stock. Nosecone 130 enables this process by creating a surface around the cutting stylus that effectively stops further progression of the stylus into the stock once the surface of the nosecone meets the surface of the stock. Therefore, the cutting stylus is extended a fixed, specific distance away from the surface of the nosecone, ensuring that the cutting depth will always be the same despite variations in dimensions of the individual pieces of stock.

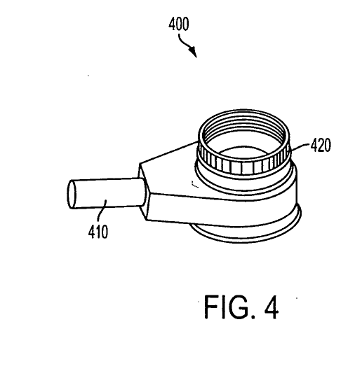

According to some embodiments, nosecone 130 may include an integrated vacuum attachment. As depicted in FIG. 4, a nosecone 400 is provided with an integrated vacuum attachment 410 and a spindle connector 420 for connecting to an engraving spindle (not shown). Vacuum attachment 410 may be used to remove waste material, such as shavings, cuttings, dust, flakes, vapor, and/or other debris, preventing the debris from adhering to the stock item, and from falling into the area that has been engraved, which would mar the appearance of the engraved area.

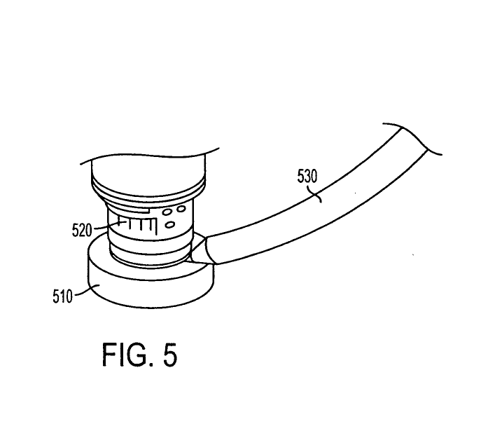

While nosecone 400 includes an integrated vacuum attachment, a separate vacuum hose may be provided for removing debris. As depicted in FIG. 5, a nosecone 510 is attached to an engraving spindle 520. Vacuum hose 530 is also attached between the engraving spindle 520 and the nosecone 510. Vacuum hose 530 may be configured to provide the same waste removal functions described above in reference to vacuum attachment 410. By providing a sealed area that concentrates the suction from the vacuum hose to the area around the cutting stylus, the nosecone helps to concentrate the suction power from the hose, thereby increasing suction power.

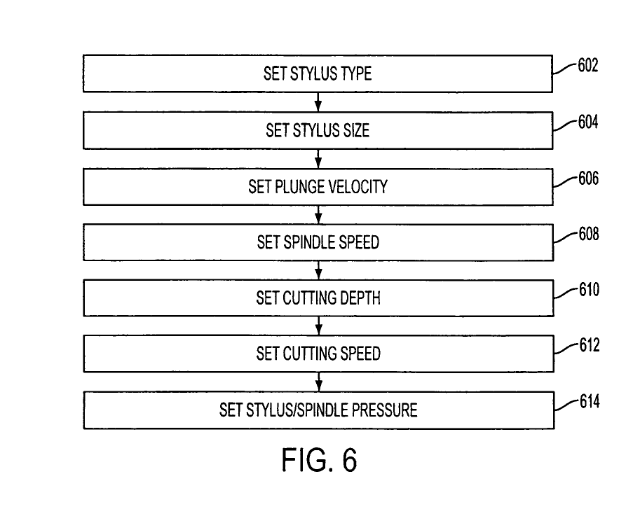

In order to use an engraving/milling machine to create personalized stock items, the engraving/milling machine must be appropriately programmed to create three-dimensional markings on the soap or candle stock. The machine may be programmed to affiliate milling/engraving instructions with each of the positions occupied by the surface of a piece of stock in one of the positions in a nest. The machine may also be programmed to translate a specified font, font size, font style, and character set to be used into a set of engraving instructions. FIG. 6 depicts a process for programming an engraving/milling machine.

As depicted at 602, a stylus type may be set. Typical engraving/milling machines are able to accommodate various types of stylus. In accordance with some embodiments, a stylus is selected which is able to create the most aesthetically pleasing results while also assisting with the ejection of waste materials from the surface of the stock so that it can be easily evacuated by a suction hose. For example, quarter round and/or half round styluses have been determined to provide this affect.

The size of a stylus is also important in creating an aesthetically pleasing product. Accordingly, the stylus size for the milling/engraving machine may be set, as depicted at 604. For example, styluses ranging in size to 0.015 inches to 0.050 inches in diameter have been determined to generate an aesthetically pleasing result.

As depicted at 606, the plunge velocity, which is the speed at which the stylus/cutting head moves in the z (vertical) direction, may be set. The plunge velocity refers to the speed at which the stylus/cutting head impacts the surface of the stock when it begins cutting. According to some embodiments, multiple passes may be needed to create complex markings. A plunge velocity between 0.4 inches per second and 1.0 inches per second results in proper cutting. The speed at which the spindle turns also facilitates the cutting action of the stylus and affects the resulting product. Accordingly, the spindle speed may be set, as depicted at 608. For example, a spindle speed in the range of 8000 rpm to 12,000 rpm provides the appropriate speed for engraving the soap and candle stock described herein.

As depicted at 610 and 612, the cutting depth and cutting speed may be set to values which achieve the best appearance. For example, a cutting depth between 0.03 inches and 0.08 inches creates an aesthetically pleasing product. The cutting speed refers to the speed at which the cutter moves through the stock once it has impacted the stock and moved through the proper depth. For example, an x-y direction cutting speed of between 0.5 inches per second and 1.5 inches per second may be used.

The stylus/spindle pressure also affects the appearance of the finished product. Accordingly, the stylus/spindle pressure may be set, as depicted at 614. A specific amount of downward force should be exerted on the stock by the stylus and spindle during the cutting process to enable the production of visually appealing markings. According to some embodiments, a pressure in the range of 0.6 pounds to 2.5 pounds may be used. The appropriate pressure may depend on a variety of factors such as, for example, the temperature of the soap or candle stock, and the ingredients used to create the soap or candle stock.

To determine the amount of pressure exerted on the soap or candle stock by an engraving/milling machine regardless of the model or manufacturer, a scale of appropriate sensitivity is placed directly beneath the stock to be marked such that the entire piece of stock is supported by, and centered on, the surface of the scale. An ordinary sized soap or candle stock is positioned, still centered on the scale, beneath the stylus/spindle of the machine such that it is in position to create a set of markings (such as a logo or an initial) that would appear centered on the surface of the soap or candle opposite the surface that is in contact with the scale. The machine is configured as described above (i.e., with a selected stylus type, size, plunge velocity, spindle speed, cutting depth and cutting speed). The engraving process is begun, and the pressure on the scale is noted after the stylus has penetrated the stock and while it is engraving/removing material.

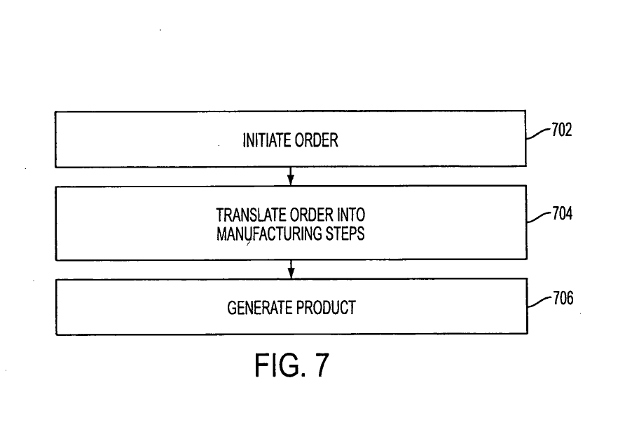

FIG. 7 depicts a process for initiating and filling an order for personalized items, such as soap or candles. An order is initiated, as depicted at 702, when order information is received specifying one or more desired products. According to some embodiments, a customer may place an order via the Internet. This enables the user to view collections and personalization options via one or more order menus. Further, the customer is able to directly input the desired letters and/or characters to personalize the ordered products, thereby eliminating re-keying errors. Upon entering the desired specifications, the customer may be presented with an image depicting their selections. Ordering via internet also enables the customer to upload custom logos by attaching files containing the logo. Orders may also initiated via facsimile, phone, and/or email.

Order information may include, for example, the type of product desired (i.e., soap, candles, etc.), the quantity, the type of personalization to be applied, and/or other product details. The order information may indicate that the customer wishes to purchase a collection, which may consist of a predefined grouping or set of products. Additionally, one or more individual products may be purchased.

Importantly, the order information may also include instructions for personalizing the ordered products. The instructions may include, for example, the particular characters or logos that are to be engraved into the desired product(s). The customer may specify a particular font style and size. The customer may also wish to select from a library of standard logos and other symbols.

As depicted at 704, once the order information has been received, the information is translated into one or more manufacturing steps. Translating the instructions into manufacturing steps may include selected the specified stock from inventory, mounting the stock into the nest, and programming the engraving/milling machine with instructions which translate the specified characters, symbols, and/or logos into milling instructions. For each unique position in the nest, a set of engraving/milling instructions are specified. For example, a piece of soap stock placed in row 1, column 1, might have a single initial specified for its marking instructions, but the bar in row 2, column 4 might require that the word “MOM” in all capital letters be placed on it.

Once the milling instructions have been generated, the product is generated, as depicted at 706. The engraving/milling machinery is used to apply uniquely specified three-dimensional markings assigned to the unique stock in the particular position in the nest. The machine may be programmed to affiliate milling/engraving instructions with each of the 1 to n positions occupied by the surface of a piece of stock in one of the positions in the nest. Pressure is applied to the stock, based on the parameters described above in reference to FIG. 6, to create the finished products.

In certain embodiments, the soap or candle stock is refrigerated or frozen prior to placing it in the nest cavity 202. Lowering the temperature of the stock makes the stock more brittle, so the machine tool cuts cleaner, thereby improving the appearance of the finished products.

The present disclosure provides an economical method and apparatus for creating large quantities of soap, candles, or other items where every item could have unique markings. As a result, the present disclosure opens up entirely new markets, especially for commemorative, holiday, or special occasion gifts where individuals or groups can have high quality items created featuring letters, monograms, symbols, slogans and/or logos in lots as small as a single item, for a cost that is a fraction of what would be incurred employing conventional methods and machinery.

The present disclosure enables an unlimited variety of three-dimensional markings of extreme intricacy and beauty to be placed onto the surface of soap bars, soap cakes, candles, etc., dramatically expanding the variety and attractiveness of the decorations, lettering, logos, emblems, words, characters, symbols, and monograms that can be incorporated into the items. The legibility of such markings is also improved compared to other methods of applying markings to candles and soap stock.

The cost of creating small batches, or even single, personalized candles or bars or cakes of soap with unique markings is reduced, making it possible to vary the markings from item to item without requiring the creation of new equipment such as dies, molds, included object handles, or label handles for each item. Conventional die and molding methods of marking candles and soap typically require equipment costing hundreds of thousands of dollars to produce. Costs are dramatically reduced using the methods and apparatus of the present disclosure.

The methods and apparatus of the present disclosure also reduce the time required to create small batches or individual personalized items from candle or soap stock that feature unique markings, since the process does not require the creation of dies, molds, included objects or preprinted labels or stock, and the associated downtime to re-configure machinery to accommodate these items. Conventional processes require hours or days to re-configure machinery to accommodate a custom logo, in addition to the time required to create dies, molds, preprinted label stock and the like. Using the present methods and apparatus, the time required to change over to a new custom lettering or logo is reduced to minutes or seconds.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims.

What is claimed is:

1. A nosecone comprising:
a top portion attachable to a spindle of a machine tool;
a bottom rim for contacting stock to be machined by the machine tool and for distributing a downward pressure of the machine tool applied to the stock; and
a body between the bottom rim and the top portion, for preventing contact between the stock and the spindle and for preventing a stylus of the machine tool from penetrating the stock before a predetermined amount of pressure is applied to the stock from the machine tool.

2. The nosecone of claim 1, wherein the top portion further comprises a spindle connector for attaching the nosecone to the spindle.

3. The nosecone of claim 1, wherein the body is tubular and encloses an interior of the nosecone body, and the body further comprises a through-hole and a suction hose communicating with the interior of the nosecone body via the thru-hole.

4. A system comprising:
a machine tool having a spindle and a stylus;
a nosecone comprising a top portion attachable to a spindle of the machine tool; a bottom rim for contacting stock to be milled or engraved by the machine tool and for distributing the downward pressure of the machine tool applied to the stock; and a body between the bottom rim and the top portion, for preventing contact between the stock and the spindle and for preventing a stylus of the machine tool from penetrating the stock before a predetermined amount of pressure is applied to the stock from the machine tool; and
a holding device comprising a semi-rigid material and having at least one nest cavity for holding the stork while the pressure is applied to the stock.

5. The system of claim 4, wherein the holding device comprises delrin.

6. The system of claim 4, wherein each nest cavity of the holding device is lined with strips of a flexible material.

7. The system of claim 4, wherein the stock comprises soap stock.

8. The system of claim 4, wherein the stock comprises candle stock.

9. The system of claim 4, wherein the stylus of the machine tool is a quarter round stylus.

10. The system of claim 4, wherein the stylus of the machine tool is a half round stylus.

11. The system of claim 4, wherein the stylus of the machine tool has a diameter of about 0.015 inches to about 0.050 inches.

12. The system of claim 4, wherein the body of the nosecone body is tubular and encloses an interior of the nosecone body, and the body further comprises a through-hole and a suction hose communicating with the interior of the nosecone body via the thru-hole for removing particulates and creating a sealed, low pressure area when the bottom rim of the nosecone contacts the stock.

13. A method for engraving semi-soft stock, the method comprising:
providing a machine tool;
affixing a top portion of a nosecone to a spindle of the machine tool, the nosecone further comprising a bottom rim and a body between the bottom rim and the top portion for preventing contact between the stock and the spindle and for preventing a stylus of the machine tool from penetrating the stock before a predetermined amount of pressure is applied to the stock from the machine tool;
providing a holding device having at least one nest cavity for holding the stock;
placing the stock in the nest cavity;
defining the location of the holding device to the machine tool;
programming the machine tool with engraving instructions;
contacting the bottom rim of the nosecone with the stock;
distributing a downward pressure of the machine tool to the stock through the nosecone bottom rim;
creating a low pressure area in the region enclosed by the stock and interior of the nosecone by applying a vacuum to the suction hose; and
engraving the stock according to the engraving instructions.

14. The method of claim 13 further comprising receiving the engraving instructions from a customer order.

15. The method of claim 13, further comprising selecting soap stock.

16. The method claim of 13, further comprising providing suction to the body of the nosecone to remove particulates from the vicinity of the nosecone.

17. The method of claim 13, further comprising setting the plunge velocity of the machine tool to about 0.4 inches per second to about 1.0 inches per second.

18. The method of claim 13, further comprising setting the spindle speed on the machine tool to about 8000 rpm to about 12000 rpm.

19. The method of claim 13, further comprising setting the cutting depth of the machine tool to about 0.03 inches to about 0.08 inches.

20. The method of claim 13, wherein the machine tool cuts in an xy direction at a speed of about 0.5 inches per second to about 1.5 inches per second.

21. The method of claim 13, wherein a downward pressure of about 0.6 pounds to about 2.5 pounds is applied to the stock through the bottom rim of the nosecone and/or the stylus by the machine tool.

22. The method of claim 13, comprising selecting candle stock.

23. The method of claim 15, comprising refrigerating or freezing the soap stock prior to placing the soap stock in the nest cavity.

24. The method of claim 22, comprising refrigerating or freezing the candle stock prior to placing the candle stock in the nest cavity.
